(19) United States
(12) Patent Application Publication
(10) Pub. No.: US 2005/0223172 A1
(43) Pub. Date: Oct. 6, 2005

(54) Instruction-word addressable L0 instruction cache

(76) Inventor: Ulrich Bortfeld, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/816,144

(22) Filed: Mar. 31, 2004

(51) Int. Cl. G06F 12/00

(52) U.S. Cl. 711/125

(57) ABSTRACT

Methods and apparatuses associated with an L0 instruction cache. An L0 instruction cache stores sequences of instruction data and can be accessed in a single instruction clock cycle. In one embodiment pointers are used to define a window of valid instruction data. Instructions are stored in the cache sequentially, without empty memory space between the end of one instruction and the beginning of another. Instructions are read and aligned from the L0 cache and sent to the instruction latch. Alignment is performed with a permutation unit that correctly orders the separate instruction data elements read from the cache memory.

### FIELD

Embodiments of the invention relate to instruction caching, and particularly to an L0 instruction cache.

### BACKGROUND

When a processor makes a jump or a branch, traditional systems incur a three clock cycle penalty, because the processor must wait through three cycles of non-useful processor execution (a “nop” instruction) for the sequencer fetch mechanism to fetch the instructions of the branch or jump target. In large processors trace caches have been employed to avoid the delay associated with the use of the non-useful instruction cycles. A trace cache stores one or more series of instructions in execution order. The series may span several branches, with the branch determinations responsible for creating the trace being a part of the trace. Processors typically have multiple levels of memory. The structure of the memory is typically larger and slower the more levels away from the processor, with the smallest, fastest memories often residing in the same die as the processor.

Some code requires a processor to execute instructions in a cyclic sequence, or a loop. The bottom of the loop calls a jump back to the top of the loop. This will result in the delay penalty discussed above. However, most loops are small in terms of number of instructions executed during the loop. Because most loops are small, processors may include a zero-overhead loop buffer that stores the first several instructions of a loop to avoid the delay normally incurred when jumping from the end to the beginning of the loop. When the loop bottom is reached, rather than having to wait to fetch the first instructions of the loop, the first loop instructions are buffered, and immediately available for execution by the processor. This allows sufficient time for the sequencer to fetch the next group of instructions as the processor executes the first instructions of the loop. Thus, the loop overhead associated with jumping from the loop bottom to the loop top is avoided.

Because of the function of the loop buffer in storing the first set of loop instructions, loop buffers may be considered in a sense an L0 cache. However, the implementation of loop buffers has been traditionally very wasteful of system resources. FIG. 1 is a prior art example of hardware loop buffering. In traditional loop buffering, all data paths shown are of the same size. In FIG. 1, the data paths are shown to be of size y, which may be, e.g., 32 bits, 64 bits, etc. Instruction latch 130 will normally hold instructions that come from alignment buffer 110 that will be forwarded to the decoder. In the normal logic of instruction execution, alignment buffer 110 is located between the instruction fetch stage and the decoder. As shown, instructions will come to alignment buffer 110 from an L1 cache and go on the instruction decoder.

It is increasingly common for processors to support instructions of variable instruction size. That is, some processors support both 16 and 32 bit instructions, and others also support 64 bit instructions. In this sense, an instruction word could be considered 16 bits, and instructions that are of bigger size could be considered to be multiple instruction words in length. The expression “instruction word” is a way to describe a smallest unit of usable instruction data, whether it be one or multiple bytes in size. System 100 includes loop buffers LB0 120 and LB1 121. In one embodiment system 100 is part of a processor that supports variable instruction sizes. Thus, note that loop buffers will be inefficient in their use of resources. The bus to loop buffers LB0 and LB1 are of size y, which may be four times the width of some instructions (64=16*4). Thus, even when a 2 byte instruction is to be input into LB0 130, an 8-byte storage location is dedicated to holding the instruction. Because instruction latch 130 may receive instructions from loop buffers LB0 120 and LB1 121 as an alternative to receiving instructions from alignment buffer 110, the instruction data received from LB0 120 and LB1 121 should also be aligned as it would be from alignment buffer 110. The need to align the instruction data for transmission to instruction latch 130 creates the wasteful use of resources, where parts of the loop buffers may be left empty to ensure proper alignment of instructions.

FIG. 1 also shows two loop buffers to represent the fact that a dedicated loop buffer is traditionally required for each level of nesting. Thus, system 100 as shown would support hardware buffering of two nesting levels. This results in another inefficiency in system 100, in that no more than one buffer will actually be actively used at a time. Thus, to provide for increases in performance, traditional systems have taken a penalty in resource size and efficiency. This results in using more die space than might be needed, and also in the use of empty buffers results in significant power dissipation in processor systems that perform significant amounts of looping, such as DSPs in cell phones, PDAs, or other handheld devices.

Note that the discussions above are with reference to instruction caching. Data caching may use similar techniques, but traditionally instruction caching and data caching have been handled in different ways.

### BRIEF DESCRIPTION OF THE DRAWINGS

The description of embodiments of the invention includes various illustrations by way of example, and not by way of limitation in the figures and accompanying drawings, in which like reference numerals refer to similar elements.

FIG. 1 is a prior art example of hardware loop buffering.

FIG. 2 is one embodiment of a block diagram of a processor having an L0 instruction cache.

FIG. 3 is one embodiment of a block diagram of a sequencer with an L0 instruction cache.

FIG. 4 is one embodiment of a block diagram of an L0 instruction cache.

FIG. 5 is one embodiment of a flow diagram of control of an L0 instruction cache.

FIG. 6 is one embodiment of a flow diagram of control of the PC for use with an L0 instruction cache.

FIG. 7 is one embodiment of a block diagram of an L0 instruction cache loaded with instructions.

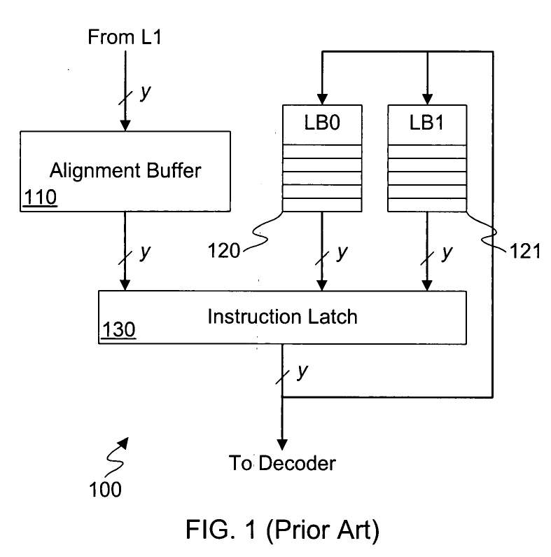

### DETAILED DESCRIPTION

Methods and apparatuses associated with an L0 instruction cache are described. A memory structure with word-addressable storage locations holds instruction sequences that can be accessed in a single instruction clock cycle, similar to a trace cache.

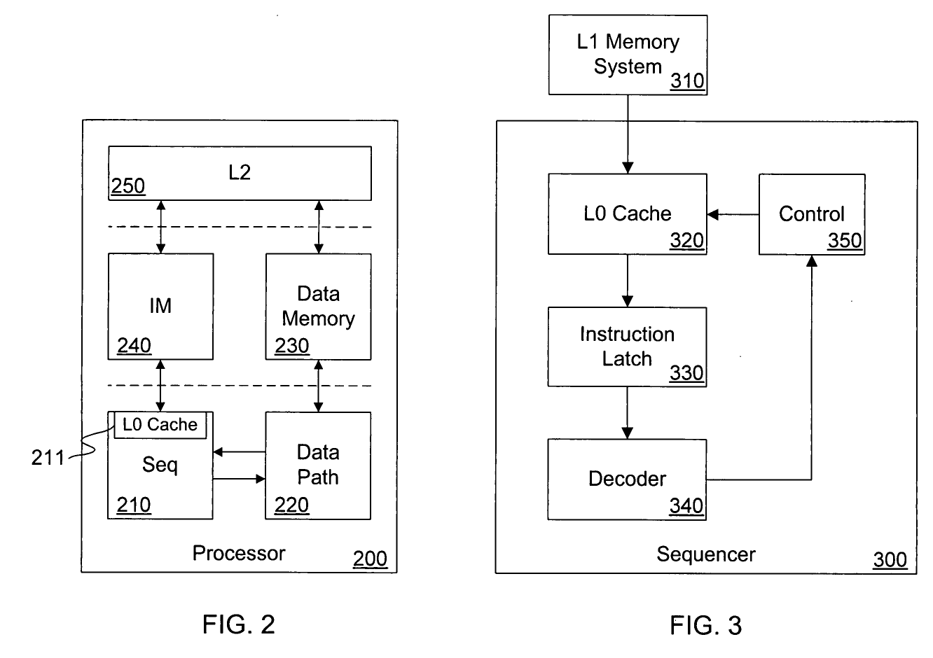

FIG. 2 is one embodiment of a block diagram of a processor having an L0 instruction cache. Processor 200 includes a three-level memory system. The memory system structure includes a data memory path and an instruction memory path. Data for data path 220 is received from data memory 230, an L1 memory system. The data path 220 may send addresses to data memory 230, which may return data corresponding to the data address. Likewise, if data memory 230 sends a data request for an address, data path 220 may return the data. L1 memory system memory 230 may include one or more separate components of Synchronous Random Access Memory (SRAM) and/or cache memory, on-chip storage structures, etc.

The L1 memory system on the instruction path may include one or more separate components of a SRAM and/or cache memory to make up instruction memory 240. Sequencer 210 will generally make instruction data requests to instruction memory 240, which returns the instruction data corresponding to an address of the instruction data request.

Both the instruction path and the data path access L2 memory system 250. L2 memory system 250 may be one or more of, or a combination of, SRAM and/or flash. L2 memory system 250 holds both instructions and data, and is accessed by L1 memory systems.

Sequencer 210 also includes an L0 cache 211 for caching instruction data. L0 cache 211 allows sequencer 210 to store and access instructions, typically instructions that are recently used and within a certain offset of the program counter (PC).

In one embodiment processor 200 supports variable instruction word size. When instructions are of a fixed size, instruction alignment is performed by simply reading the instructions out of L0 cache 211 in a sequential fashion from their memory locations. The start of every instruction will occur at sequential offsets. When instructions are of variable size, processor 200 may not know the size of the instruction to be executed until the decoder stage. By placing any type of L0 caching system logically between the instruction fetch and instruction decode stages of the instruction pipeline, the instructions will be read out of the cache prior to knowing what size the instructions will be read. For this reason traditional approaches, such as loop buffering, waste resources by requiring instructions of whatever size be stored in a memory location of fixed size (the maximum expected instruction word width) so that all instructions will be stored aligned.

However, L0 cache 211 supports storing of instructions in contiguous memory locations, regardless the size of the instruction. Thus, a 2-byte instruction may be stored contiguously with a 4-byte instruction, without having a 2-byte instruction partially occupying 4- or 8-bytes of memory locations, and then having the 4-byte instruction also occupy 4- or 8-bytes of memory locations, as is traditionally done. This allows L0 cache 211 to store instructions in a more efficient way, without unused memory locations within the valid instruction space. L0 cache 211 then aligns the instructions on a read from L0 cache 211 to pass the instructions to the decoder.

FIG. 3 is one embodiment of a block diagram of a sequencer with an L0 instruction cache. Sequencer 300 includes L0 cache 320, instruction latch 330, decoder 340, and control 350. Sequencer 300 receives instruction data from L1 cache 310, as discussed above. In the embodiment shown in FIG. 3, sequencer 300 may store certain instructions in L0 cache 320.

Instructions are read from L0 cache 320 to instruction latch 330 and passed on to decoder 330, similar to that discussed above with reference to these elements. The alignment of contiguously-stored variable-sized instructions is discussed below for embodiments of a system having L0 cache 230 that supports variable instruction sizes.

L0 cache 320 holds instruction data in sequential, or lexical order. The order in which the instructions occur in the system of which sequencer 300 is a part is the order in which they are stored in L0 cache 320. L0 cache 320 stores the instructions in contiguous memory locations within the cache. L0 cache 320 supports storing instructions in contiguous memory locations for all supported instruction sizes in the system. Stored in contiguous memory locations is to be understood to mean stored in memory locations that have sequential relative cache addresses, and without empty, or invalid memory space between. This is in contrast to traditional instruction buffering that required all instructions, regardless of size, to be stored in memory locations of a fixed size of the maximum instruction size. L0 cache 320 stores instruction sequences. As instructions in the instruction pipeline are accessed, they may be stored in L0 cache 320.

L0 cache 320, in contrast, has word-addressable memory locations. A memory location may be only as large as the minimum instruction word size, and every memory location is addressable. Thus, L0 cache 320 may store a 2-byte instruction in one memory location, and a 4-byte instruction in the next logical (according to address) memory locations in L0 cache 320. An 8-byte instruction could then be stored in the next available four memory locations. This assumes an instruction word of 2 bytes, or 16 bits. However, what is described herein would work equally well in a system that supported, for example, both 8 bit and 16 bit instructions (in this case an instruction word would be 8 bits in width). L0 cache 320 is thus addressable at each instruction word in the cache. Note that instructions of larger size could be considered multi-word instructions, and each word of the multi-word instruction is separately addressable. For example, a 32 bit instruction in a 16 bit word processor would be addressable in L0 cache 320 as two words of instruction data: the first 16 bits of instruction data and the second 16 bits of instruction data would be separately addressable.

In one embodiment L0 cache 320 may be understood to have lines of memory, each memory location in the line separately addressable. As such, instruction data may be written into L0 cache 320 in entire lines. Thus, a line width of instruction data would be accessed and written into L0 cache 320. Note that in a variable instruction size processor, this may result in reading instruction data that is only part of a complete instruction. For example, a line width of instruction data may include the first instruction word of a multi-word instruction in the last memory location. The next read of a line of instruction data would retrieve the other word or words of the instruction. In this case, an instruction word may be said to “straddle” lines in L0 cache 320. One characteristic of an L0 cache is that the instructions are retrievable from the cache in a single instruction clock cycle. In order to access this instruction, a misaligned memory read must be supported by L0 cache 320. This will be discussed further below.

Importantly, L0 cache 320 does not have some of the features of a regular cache. For example, typical caches include a tag array to access various instructions within the instruction cache. The use of a tag array is known in the art. The use of a tag array would present particular problems in a cache such as L0 cache 320 that stores instruction data in contiguous memory locations. Because of the use of contiguous memory locations, instructions may straddle lines of memory storage within L0 cache 320. It would be difficult, if not impossible, to read an instruction in a single clock cycle that straddled memory lines with the use of a tag array. Because separate lines of storage within the cache are involved, there would be at least two tag array accesses in order to read the instruction. Also different from typical caches is the fact that L0 cache stores instructions in lexical order.

Control 350 receives data from decoder 340. The data is used to determine a memory offset into the memory locations of L0 cache 320 based on the PC. Thus, the data sent to control 350 may include the instruction size, the next PC address, or a next relative PC that describes the PC address in terms of the addresses of L0 cache 320. Control 350 uses this information to provide alignment of instructions read from L0 cache 320.

L0 control 350 may provide address write and read control for the addressable memory locations of L0 cache 320. As each instruction data word is addressable within L0 cache 320, control 350 provides a way to address each instruction data word without the use of a tag array. One simple way to accomplish this is through the use of pointers. In one embodiment a top pointer and a bottom pointer are defined that define a “window” of valid instruction data in the cache, the top pointer pointing to the top-most valid instruction, and the bottom pointer pointing to the bottom-most valid instruction. The valid instruction data is that with addresses higher than the top pointer, and lower than the bottom pointer. The window can be collapsed by setting the top and bottom pointers equal to each other, which will invalidate the instruction data in the cache. The window can have a maximum size of the cache size. Control 350 may also provide instruction alignment for L0 cache 320, which will be discussed below.

In one embodiment L0 cache 320 is used to support zero-overhead loop buffering. A traditional loop buffer stores at least the first instructions of a loop to provide a buffer for the jump from loop bottom to loop top. Without loop buffering, every jump from loop bottom to loop top would result in a fetch delay, as discussed above. Because a loop buffer stores the beginning instructions of the loop, the instructions can be received in a single instruction cycle, avoiding the fetch delay. By the time the first instructions of the loop are executed, the fetch mechanism will have filled the pipeline, enabling the system to begin operating out of the pipeline again.

Control 350 and L0 cache 320 may provide loop buffer support as follows. In one embodiment L0 cache 320 simply stores instructions as instructions are executed from the pipeline, and when a jump is made, the address is found in L0 cache 320, avoiding a read from L1 cache. This prevents the delay associated with accessing L1 cache for the jump from the loop bottom to the loop top. This would assume that L0 cache is active during execution of the loop. In an alternate embodiment, control 350 includes a loop_ top pointer to indicate the beginning of a loop, and a loop_bot pointer to indicate the bottom of the loop. The instruction size of the loop can be compared against the size of L0 cache 320 to determine if the loop will fit inside L0 cache 320. If it can, L0 cache 320 is activated and the loop is stored in L0 cache 320. Thus, there will be no read to the L1 memory system for the duration of the loop, saving clock cycles normally associated with fetch delays, and saving power associated with L1 access.

Note that in some cases the loop size will exceed the size of L0 cache 320 and an uncached jump to the loop top may be unavoidable. While a fetch delay will be incurred, this may not be a very significant penalty. For example, if a loop contained 60 instructions, and the L0 cache 320 could only hold half of the instructions, an L1 access penalty of 3 instructions would only incur a 5% penalty on execution. Contrast that with the situation in which a loop contains only six instructions, and all could be stored in L0 cache 320. The L0 cache 320 would be saving a 50% penalty on execution of every iteration of the loop. Loops of small size are particularly common in DSPs that run cell phones, PDAs, etc.

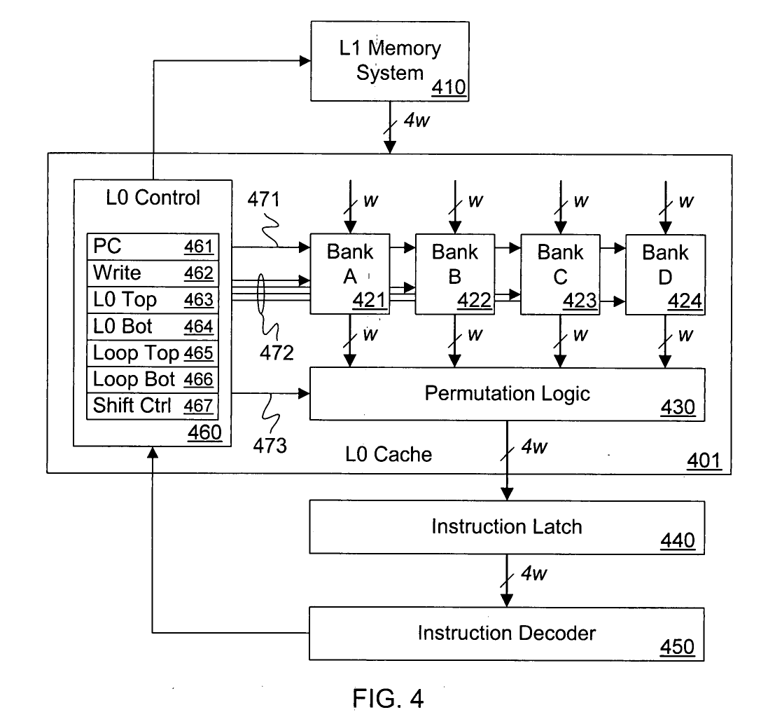

FIG. 4 is one embodiment of a block diagram of an L0 instruction cache. In this embodiment of an L0 instruction cache, L0 cache 401 includes separate banks 421-424 of memory locations. Each row of each bank 421-424 is independently addressable. The four banks 421-424 are to be understood only as an illustration, and there may be more or fewer memory banks in L0 cache 401.

L1 cache 410 delivers instruction data to L0 cache 401. L1 is shown with a bus width of 4w, meaning four instruction data words could be delivered at a time to L0 cache 401. The use of four instruction data words is a logical choice when four separate memory banks are employed. If L0 cache 401 included fewer or more banks, the number of instruction data words delivered by L1 cache 410 could be adjusted accordingly for simplicity of implementation. The addressing of memory locations of the banks 421-424 is discussed in more detail below. In one embodiment memory banks 421-424 are one instruction data word in width. Note that breaking the instructions at instruction data word width provides simple addressing. However, byte addressing could be performed, as well as two-word wide memory locations and addressing. These would create other issues as far as instruction alignment is concerned, but could be performed in a similar fashion to that discussed here.

When instruction data is read from memory locations in banks 421-424, the read data is sent to permutation unit 430 to provide proper alignment of the instructions to send to instruction latch 440. Permutation unit 430 is a series of logic gates and/or logic functions that performs shifting, shuffling, multiplexing, or other permuting of instruction data words. Note that on every instruction read, an instruction data word will be read from each of banks A 421, B 422, C 423, and D 424. However, because the pointer indicating the top-most valid instruction data may point to any instruction data stored at any location within L0 cache 401 (L0 top pointer), the read may start in any of the four storage cells shown. Thus, if the pointer points to an address in C 423, a read will cause the instruction data word at the pointer to be read, as well as the instruction data word in the same line in D 424, the instruction data word in the next line in A 421, and the instruction data word in that next line in B 422. The four instruction words that are delivered to permutation unit 430 from the banks 421-424 are ordered as A, B, C, D. The proper order of the instruction data words is C, D, A, B, because the top valid instruction data was found in bank C 423. For permutation unit 430 to deliver a properly aligned instruction to instruction latch 440, permutation unit 430 rearranges the instruction data words to the order C, D, A, B, and passes the instruction to instruction latch 440. Instruction latch 440 will in turn pass the aligned instruction on to instruction decoder 450.

Instruction decoder 450 is shown passing information to L0 control 460. This data is the information described above that provides the PC address and/or offset to L0 control 460. In one embodiment L0 control has PC 461, an address received or derived from the data received from instruction decoder 450. L0 control 460 also includes write control 462 to indicate that an instruction data word is to be written to the banks 421-424. L0 control includes L0 top 463 and L0 bot 464, which are pointers that define the window of valid instruction data.

L0 control also includes shift control 467 to control the logical functions of permutation unit 430. For example, in one embodiment L0 cache 401 includes two memory banks A and B. If shift control 467 is a 0, permutation unit may return the instruction data word order A, B. If shift control 467 is a 1, permutation unit may return the instruction data word order B, A. In one embodiment L0 cache 401 includes four memory banks 421-424, A, B, C, and D. When shift control is a “00,” permutation unit 430 may return the instruction data word order A, B, C, D. When shift control 467 is “01,” permutation unit 430 may return the instruction data word sequence D, A, B, C, and a “10” returns C, D, A, B and “11” returns B, C, D, A. Other combinations may be used.

In one embodiment L0 control 460 includes loop top 465 and loop bot 466, which point, respectively, to the top and bottom instructions of a loop stored in L0 cache 401. With these pointers, L0 cache can act as a loop buffer, as explained above.

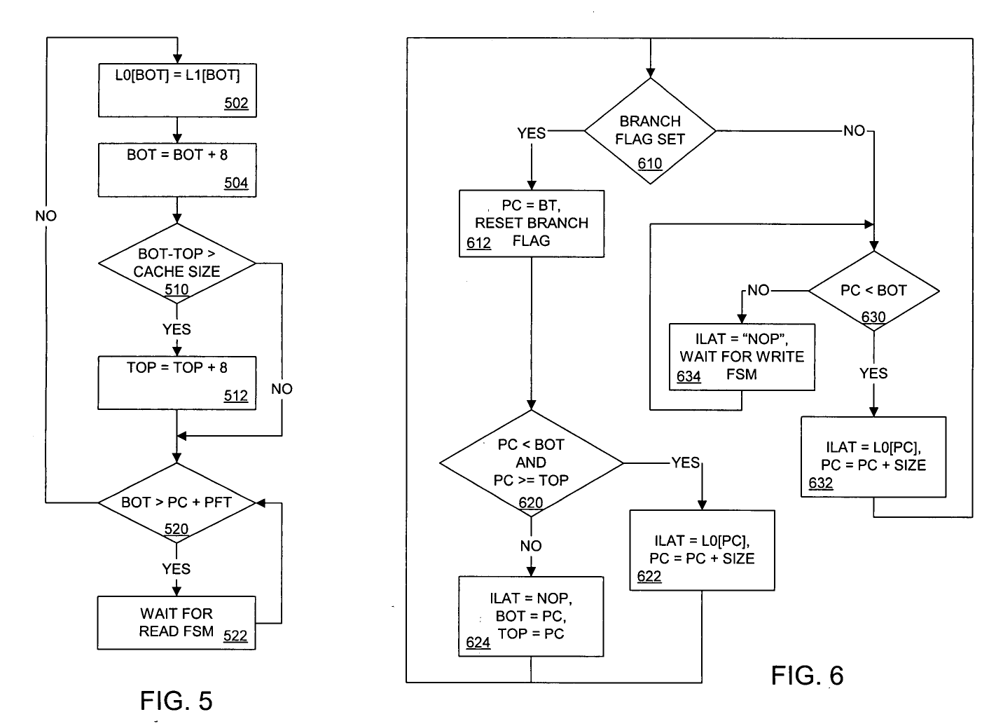

FIG. 5 is one embodiment of a flow diagram of control of an L0 instruction cache. When the finite state machine (FSM) of the L0 cache indicates a read, the L0 cache will store instructions in its memory locations. As discussed herein, pointers are used to indicate the top and bottom of valid instruction data within the L0 cache. When the L0 cache is enabled to store instruction data, its bottom pointer L0[bot] is set to the address location of the bottom-most valid instruction in the L1 memory system, 502. The L0 cache may not be used or required to store every instruction in the instruction pipeline; thus, execution of instructions in the pipeline may have been performed prior to the L0 cache being enabled to read and store the instructions. This makes it important to reset the L0[bot] pointer to be at the proper address for the next instruction fetch. Note that if the L0 cache had been active during the previous instruction fetch, the L0[bot] pointer would already be equal to L1 [bot].

The fetched instruction data is stored in the L0 cache, and the L0_bot pointer is updated by an offset equal to the number of instruction bytes read, 504. In the embodiment shown, eight instruction data bytes were read and stored in the L0 cache. Alternatively, a number of bytes other than eight may be used, and L0_bot would be incremented by the different number.

The L0 control determines if the offset between the L0_bot and the L0_top pointers is greater than the cache size, 510. The offset between the L0_bot and the L0_top pointers defines the window of valid instruction data. However, the L0 cache will be of a fixed size. If the read that was just finished makes the address of the L0_bot pointer at an offset from the L0_top pointer greater than the physical size of the L0 cache, the read that just finished has overwritten valid instruction data, and the L0_top pointer needs to be adjusted accordingly. Thus, if instruction data has been overwritten, the L0 top pointer is also incremented by an offset equal to the read, 512. If instruction data has not be overwritten, the adjustment to the L0_top pointer is not made.

The processor determines if the L0_bot pointer is greater than the address of the PC plus a prefetch threshold, 520. The prefetch threshold is the amount of data that will be fetched in the prefetch routine. If more data was prefetched than has been stored in the L0 cache, the read and storing is repeated, and the pointers appropriately updated. If the L0_bot pointer is greater than the PC plus the PFT, all data has been stored in the L0 cache that was prefetched, and the system waits for a read cycle of the finite state machine to perform the read and storing, 522.

FIG. 6 is one embodiment of a flow diagram of control of the PC for use with an L0 instruction cache. It is determined whether the branch flag is set, 610. The branch flag indicates whether a branch or jump is to be taken, meaning that execution of instructions will occur out of program order. If the branch flag is set, a branch will be taken, the PC will be set to the address of the branch target (BT), and the branch flag will be reset, 612. It is then determined whether the PC is within the window of valid instruction data defined as the instruction data between the address of the L0_top pointer and the L0_bot pointer, 620.

If the branch target is within the window of valid instruction data, the instruction data is read and sent to the instruction latch (ILAT), and the PC is incremented by size, 622. The window of valid instruction data is discussed above, as are techniques for maintaining the pointers L0_top and L0_bot. The instruction pointed to by the PC in the L0 cache is sent to the instruction latch. This may be performed as discussed above, with multiple words read and aligned by a permutation unit, or by simply reading aligned instruction data that is already aligned, and is sent to the instruction latch. The size by which the PC is incremented refers to the size of the instruction. In one embodiment this value may be global or hardcoded, because all instructions are of the same size. In another embodiment the instructions are of variable size, and the size is determined and indicated for the L0 control logic to increment the PC by the appropriate size.

If the branch target is not within the window of valid instruction data, a nop is indicated to the instruction latch, and the L0_top and L0_bot pointers are set equal to the PC, 624. If the branch target is outside the valid window, there is no valid instruction cached for the branch target address, and a delay will be incurred in jumping to the target. By setting both the pointers equal to PC, the window of valid instruction data is collapsed, and no instruction data in the L0 cache will be valid until the FSM reaches the read state, and instruction data is to be stored in the L0 cache. Alternatively, a determination could be made as to whether the branch target is within a threshold of the L0_bot pointer. If the branch target is within the threshold, the control could simply indicate a nop to the instruction latch, but not reset the pointers, and simply wait for a read to store more instruction data in the L0 cache until the L0 cache has the branch target within its window of valid instruction data.

If the branch flag is not set, execution will occur in lexical order. A determination is made whether the PC is less than the L0_bot pointer, 630. This indicates that the PC is still within the window of valid instruction data. The setting of PC and the L0_bot pointer are not discussed with regard to FIG. 6, but are discussed elsewhere. If the PC does not point to an instruction within the window of valid instruction data, the instruction latch is set to a nop, and the system waits for a write state of the FSM, 634. The write state will place more data in the L0 cache, and increase the size of the window of valid instruction data, at which point the determination will again be made if the PC is within the valid window.

If the PC is within the window of valid instruction data, the instruction latch receives the instruction pointed to by the PC, as discussed above with respect to 622. Similarly, the PC is incremented according to the size of the instruction.

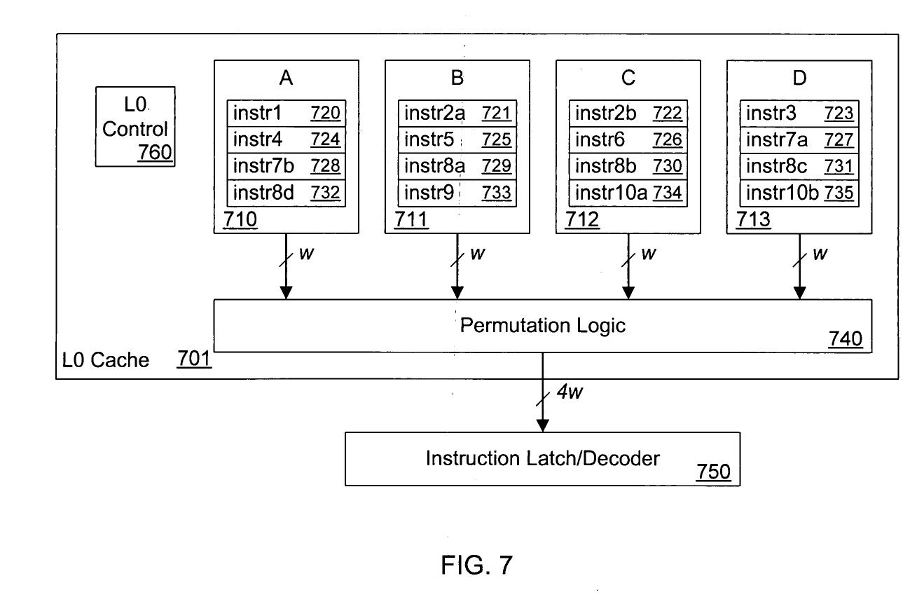

FIG. 7 is one embodiment of a block diagram of an L0 instruction cache loaded with instructions. L0 cache 701 is loaded with 64 bits at a time. The bus from an L1 memory system (not shown) from which L0 cache 701 receives instructions is 64 bits wide. When L0 control 760 enables L0 cache 701 for writing its memory locations, L0 cache 701 may write a full bus width of instruction data words to the memory locations. Thus, at times an instruction data fetch will result in fetching multiple complete instructions, and/or result in fetching instruction data words that make up only part of a complete instruction. The instruction data is stored contiguously in L0 cache 701. In alternate embodiments the bus from the L1 memory system to L0 cache 701 is 32 bits or 16 bits wide.

To begin, L0 cache 701 has no valid data, and an L0 top pointer, L0_top, is set equal to an L0 bottom pointer, L0_bot. When the write is enabled, instruction data from the instruction pipeline is loaded into L0 cache 701. After loading 8 bytes, L0_top=0, and L0_bot=8, meaning there is a window of 8 valid instruction data bytes. Storing instruction data into L0 cache 701 continues as more instruction data is stored in L0 cache 701. When execution begins, PC=0 and memory locations 720-723 are read. Note that L0 cache 701 may include more memory locations than memory locations 720-723. Also, because the memory locations are simply written and read on a basis of where the L0_top and L0_bot pointers point, memory locations 720-723 do not necessarily represent physically sequential memory locations within the hardware of L0 cache 701. That is, for example, memory location 732 shown in FIG. 7 may actually be physically the first memory location in the hardware of L0 cache 701.

Permutation logic 740 receives the instruction data read from storage cells A 710, B 711, C 712, and D 713. Thus, for this read, permutation logic 740 would initially have instruction data ordered 720, 721, 722, 723. Because PC=0, the proper start word of the current instruction is the word stored at memory location 720, which corresponds to the order of the instruction data words in permutation logic 740. Thus, no further alignment of instruction word order would be required because the instruction data is already aligned. L0 control 760 outputs a corresponding control signal to cause permutation logic 740 to use the instruction data word sequence in which the instruction data words were sent to permutation logic 740 from storage cells 710-713. Note that the first instruction instr1 is only one instruction word, or 2-bytes, in length. Because the instruction is only 2 bytes, instruction latch/decoder 750 will use the first instruction data word and discard the remaining three instruction data words. Thus, the instruction words from memory locations 722-724 are discarded and/or ignored for execution of instr1. Decoder 750 also indicates to L0 control 760 the instruction size.

L0 control 760 will update the PC to point to 721, and will cause a read of the next four instruction data words. Thus, permutation logic 740 will receive, in order, 724, 721, 722, 723. Because the PC is set to memory location 721 and the first instruction data word in the order in permutation logic 740 is the word from memory location 724, the instruction data must be aligned. L0 control 760 will output a control signal to permutation logic 740 corresponding to the fact that the L0_top pointer was pointing to a memory location in storage cell B 711, to indicate that permutation logic 740 should use an order of B, C, D, A. Permutation logic 740 permutes the data to be aligned in the order 721, 722, 723, 724, and passes the aligned instruction data to instruction latch 750. Again, not all the passed instruction data words are necessary for execution of the current instruction. Decoder 750 will determine that the instruction is two instruction words in size and will discard the instruction data words from memory locations 723 and 724.

L0 cache 721 will continue to read instructions in this fashion. Note that when PC is set to, for example, instr7, the current instruction will be an instruction that straddles the storage cells. This is because instruction instr7 includes two words, instr7a and instr7b, with one at one line of its storage cell, and the other at a different line of its storage cell. A read beginning at memory location 727 will result in permutation logic 740 receiving, in order, 728 (instr7b), 729 (instr8a), 730 (instr8b), 727 (instr7a). Permutation logic 740 will permute this group of instruction data words to align the instruction, the PC will be updated to read next at memory location 729 (instr8).

Now consider a case in which the instruction data stored in memory locations 721 (instr2) to 728 (instr7) constitutes the instructions of a software loop. A loop top pointer and a loop bottom pointer in L0 control 760 may be used to define the loop window. Because the loop window is within the size of L0 cache 721, the loop can be executed directly out of L0 cache 721 without requiring a read from the L1 memory system. Execution of the loop proceeds with instructions executed from 721/722, 723, 724, 725, 726, 727/728, in that order. At instruction instr7, the PC is reset to memory location 721 and execution is continued without incurring a branch delay because the instruction at the top of the loop are found in L0 cache 701, and without incurring penalties for reading from L1 because all loop instructions are found in L0 cache 701.

The use of a small L0 cache is primarily concerned with backward branching, meaning jumping back to instructions that have already been executed. A forward jump, meaning a jump to an address greater than the L0_bot pointer, will normally cause L0 cache 701 to collapse, meaning the L0_top and the L0_bot pointers are set equal to each other, invalidating all instruction data within L0 cache 701. A backward jump will also cause L0 cache 701 to collapse when it is a jump to an address lower than L0_top. In the case of a backward jump out of the window of valid instruction data, there may be no other choice but to invalidate the L0 cache and reload it, even if it is only lexically a few instructions before the top valid instruction.

However, with a forward jump, there may be a possibility to not invalidate the cache. If the jump is to an instruction address that has a small offset from the L0_bot pointer, the delay may be at least partially avoided. Suppose a threshold offset is defined such that addresses within the range of L0_bot plus the threshold offset will invoke, instead of a branch, a procedure to fetch more instruction data to bring the branch target within the window of valid instruction data. Thus, the system may incur some delay in fetching the additional instruction data, but would not have to invalidate all currently valid instruction data, nor would the control pointers need to be specially reset.

For example, the threshold may be set to an offset equal to two instruction-fetch widths (in a system fetching 8 bytes at a time, this would mean 16 bytes). With such a threshold, the delay will still be less than the delay that would be caused by a jump (a jump typically causes a three-cycle “bubble” of invalid instruction execution), and the cache instruction data would not have to be invalidated, nor would the control pointers need to be invalidated.

Reference herein to “one embodiment” or “an embodiment” means that a particular feature, structure or characteristic described in connection with the embodiment is included in at least one embodiment of the present invention. Thus, the appearance of phrases such as “in one embodiment,” or “in another embodiment” describe various embodiments of the invention, and are not necessarily all referring to the same embodiment. Besides the embodiments described herein, it will be appreciated that various modifications may be made to embodiments of the invention without departing from their scope. Therefore, the illustrations and examples herein should be construed in an illustrative, and not a restrictive sense. The scope of the invention should be measured solely by reference to the claims that follow.

1. An instruction memory comprising:
memory locations, directly instruction-word-addressable, to store linear sequences of instruction data in logically contiguous memory locations of increasing logical word address, including instructions that are one or multiple instruction words in size, wherein instructions stored in the memory locations may be fetched in a single instruction cycle;
memory control logic to indicate a current valid read word address of the memory locations; and
a permutation unit to receive instruction data read from the memory locations and order the instruction data according to an order of sequential operation.

2. An instruction memory according to claim 1, wherein the memory locations are byte addressable.

3. An instruction memory according to claim 1, wherein the memory locations are two-byte addressable.

4. An instruction memory according to claim 1, wherein the memory locations further comprise multiple banks of addressable locations, each bank having multiple directly addressable lines of instruction data.

5. An instruction memory according to claim 4, wherein each bank is one instruction word in width.

6. An instruction memory according to claim 1, wherein the memory control logic further comprises a pair of memory location pointers to define a window of valid instruction data.

7. An instruction memory according to claim 6, wherein a read request outside the window of valid instruction data causes the memory control logic to set the pair of pointers equal to each other to invalidate the data in the memory locations.

8. An instruction memory according to claim 7, further comprising determining if the read request outside the window of valid instruction data jump is a forward jump to an instruction address whose address offset from the current instruction address is less than a threshold, and if the address offset is less than the threshold, continuing to fetch instructions until the instruction of the forward jump has been fetched.

9. A memory structure for storing variable-instruction-size instructions comprising:
multiple rows of word-addressable instruction data memory locations, the rows of memory locations to receive instruction data in lexical order from a system level-1 (L1) cache and store the instruction data in lexical order in the rows of memory locations, wherein the instruction data is retrievable in a single instruction clock cycle; and
control logic coupled with the rows of memory locations, to provide control signals to cause reading and writing of memory locations, and to order the instruction data read from the memory locations in lexical execution order.

10. A memory structure according to claim 9, wherein the rows of memory location to store the instruction data in lexical order further comprises storing logically separable units of instruction data in sequential memory locations spanning multiple rows.

11. A memory structure according to claim 9, wherein the control logic further comprises address indicators to indicate at least a top and a bottom of a window of valid instruction data.

12. A memory structure according to claim 11, wherein the address indicators comprise an address indicator to indicate the top instruction of a loop and an address indicator to indicate the bottom instruction of a loop.

13. A memory structure according to claim 9, wherein the memory locations to store instruction data comprises the memory locations to store at least the first instructions of a software loop, and the control logic to provide control signals comprises the control logic to provide control signals to cause the reading and execution of the stored first instructions of the software loop as a zero-overhead loop buffer.

14. An electronic system comprising:
a processor having a sequencer coupled to a level-zero cache to store variable-instruction-size instructions, the level zero (L0) cache including instruction-word addressable memory locations to store a series of instruction data in execution order, each instruction of the series of instruction data retrievable in a single instruction clock cycle, the L0 cache having read and write logic to write the instruction data to the memory locations, read the data from the written memory locations, and align the data in execution order; and
a power storage cell coupled with the processor to provide power to the processor.

15. A system according to claim 14, wherein the memory locations are byte addressable.

16. A system according to claim 14, wherein the memory locations are two-byte addressable.

17. A system according to claim 14, wherein the memory locations further comprise multiple banks of addressable locations, each bank having multiple directly addressable lines of instruction data.

18. A system according to claim 17, wherein each bank is one instruction word in width.

19. A system according to claim 14, wherein the read logic further comprises memory location pointers to define a window of valid instruction data.

20. A system according to claim 19, wherein a read request for a memory location outside the window of valid instruction data causes the processor to fetch more instruction data to alter the window of valid instruction data until the requested memory location is within the window.

21. A method comprising:
storing units of instruction data in logically sequential memory locations of a level-0 (L0) storage structure;
indicating a top-most valid instruction data unit, a bottom-most valid instruction data unit, and a current instruction data unit to execute with pointers;
reading a number of instruction data units from the L0 storage structure, starting at the memory location of the current instruction data unit pointer; and
rearranging the read instruction data units to align the instruction data units in preparation for execution of an instruction.

22. A method according to claim 21, wherein the instruction data unit comprises a number of bits equal to the number of bits in a smallest instruction size supported in a processor that supports variable instruction sizes.

23. A method according to claim 21, wherein reading the number of instruction data units comprises reading a number of instruction data units equal to a maximum number of instruction data units that an instruction latch in a processor instruction sequencer can hold simultaneously.

24. A method according to claim 23, wherein reading from the memory location of the current instruction data unit comprises reading the number of instruction data units starting from a memory location in the center of a row of memory locations, and reading the instruction data units stored in all memory locations in the row from the location in the center to the last memory location in the row, and reading at least one instruction data unit from a memory location in the next row.

25. A method according to claim 24, wherein rearranging comprises shifting the read instruction data units to order the instruction data units with the current instruction data unit to occupy the least significant bytes of the sequencer.
